(19) United States
(12) Patent Application Publication
(10) Pub. No.: US 2013/0084759 A1
(43) Pub. Date: Apr. 4, 2013

(54) CONTACT AND ELECTRICAL CONNECTOR

(71) Applicant: J.S.T. MFG. CO., LTD., Osaka (JP)

(72) Inventors: Hirotaka MIZUTA, Miyoshi-shi (JP); Muneo FUKUNAGA, Miyoshi-shi (JP)

(73) Assignee: J.S.T. MFG. CO., LTD., Osaka (JP)

(21) Appl. No.: 13/644,031

(22) Filed: Oct. 3, 2012

(30) Foreign Application Priority Data
Oct. 4, 2011 (JP) 2011-220022

(51) Int. Cl. H01R 13/03; H01R 13/40

(52) U.S. Cl. 439/733.1; 439/886

(57) ABSTRACT

A contact includes an arm portion extending in a predetermined direction and having a punched surface formed by pressing. The arm portion includes the punched surface, a projecting contact portion provided on the punched surface, and a gold plating layer. The gold plating layer of the punched surface is provided only on the contact portion.

### BACKGROUND OF THE INVENTION

1. Field of the Invention

The present invention relates to a contact and an electrical connector that includes the contact.

2. Description of Related Arts

Plating is usually applied to a surface of a contact used in a connector. For example, nickel plating is applied to impart corrosion resistance and suppress solder wicking, and gold plating is applied to reduce electrical resistance.

For example, in surface processing of a contact, when a gold plating is to be applied partially after performing nickel plating, a method where a portion on which the gold plating is not to be applied (portion on which the nickel plating is to be left) is covered with a masking tape or a jig is generally employed.

On the other hand, Patent Document 1 (Japanese Published Unexamined Patent Application No. 2005-347039) proposes a method where an elongate conductive plate, having a plurality of contacts formed integrally in a row, is conveyed in a longitudinal direction and an insulating ink, insoluble to a plating liquid, is jetted from an inkjet arrangement in a direction oblique to both top and rear surfaces of the conductive plate to form a resin layer having a masking effect on both top and rear surfaces and side surfaces of the contacts.

As shown in FIG. 1 of Patent Document 1, the resin layer formed of the insulating ink is formed in a region extending from central portions to base end portions in a longitudinal direction of a pair of arm portions of each fork-shaped contact. The gold plating is thus applied to an entirety of a region extending from the central portions to tip end portions in the longitudinal direction of the pair of arm portions. The expensive gold plating is thus applied to a region of substantially half of the arm portions, thus making the contact high in manufacturing cost and consequently making an electrical connector high in manufacturing cost.

Thus, an object of the present invention is to provide a contact and an electrical connector that are low in manufacturing cost.

### SUMMARY OF THE INVENTION

To achieve the above object, in one aspect of the present invention, a contact includes an arm portion extending in a predetermined direction and having a punched surface formed by pressing, the punched surface includes a projecting contact portion and a gold plating layer, and the gold plating layer of the punched surface is provided only on the contact portion.

According to the one aspect of the present invention, an amount of gold can be reduced and reduction in manufacturing cost can be achieved because the gold plating layer provided on the punched surface of the arm portion is provided only on the projecting contact portion.

### BRIEF DESCRIPTION OF THE DRAWINGS

FIG. 1 is a sectional view of an electrical connector that includes a contact according to a preferred embodiment of the present invention.

FIG. 2 is a schematic perspective view of the contact of FIG. 1.

FIG. 3 is an enlarged perspective view of a principal portion of a first arm portion of the contact of FIG. 1.

FIG. 4 is a schematic sectional view of a principal portion of the first arm portion of the contact of FIG. 1.

FIG. 5A and FIG. 5B are sectional views of an electrical connector that includes a contact according to another preferred embodiment of the present invention, with FIG. 5A showing a state where a cover is open and FIG. 5B showing a state where the cover is closed.

FIG. 6 is a schematic perspective view of the contact of FIG. 5A.

FIG. 7 is an enlarged perspective view of a principal portion of a first arm portion of the contact of FIG. 5A.

FIG. 8 is a schematic sectional view of a principal portion of the first arm portion of the contact of FIG. 5A.

FIG. 9 is a sectional view of an electrical connector that includes a contact according to yet another preferred embodiment of the present invention.

FIG. 10 is a schematic perspective view of the contact of FIG. 9.

FIG. 11 is an enlarged perspective view of a first arm portion of the contact of FIG. 9.

FIG. 12 is a schematic sectional view of the first arm portion of the contact of FIG. 9.

FIG. 13 is a schematic perspective view of a principal portion of a first arm portion of a contact according to yet another preferred embodiment of the present invention.

FIG. 14A is a schematic sectional view of a principal portion of a first arm portion of a contact according to yet another preferred embodiment of the present invention, and FIG. 14B is a schematic view of a contact portion of the contact of FIG. 14A and a connecting member.

### DETAILED DESCRIPTION OF THE PREFERRED EMBODIMENTS

Preferred embodiments of the present invention shall now be described with reference to the attached drawings.

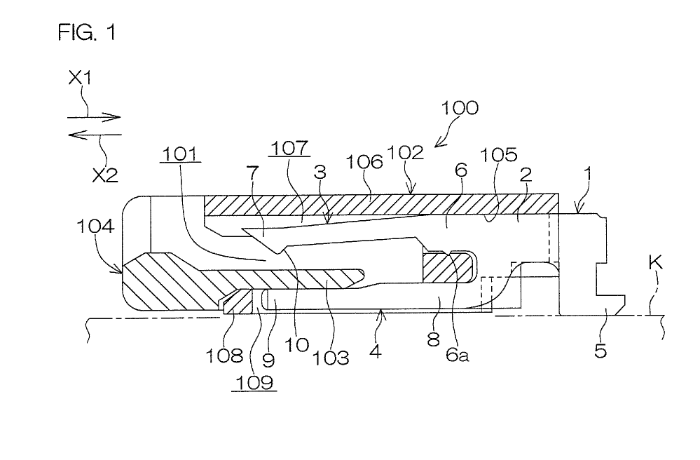

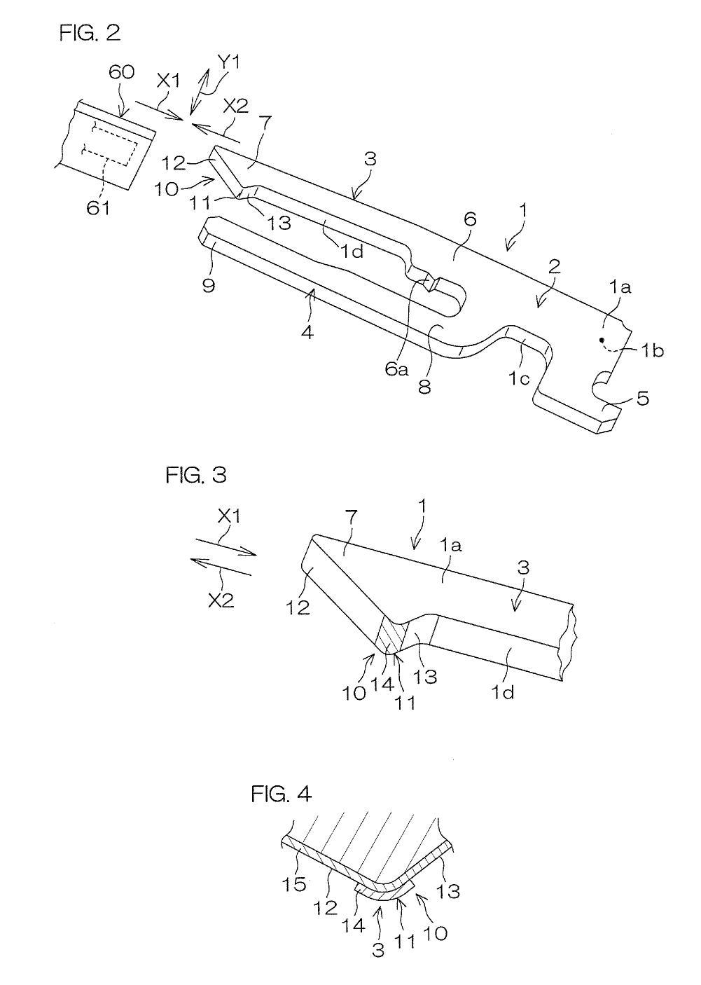

FIG. 1 is a sectional view of an electrical connector that includes a contact according to a preferred embodiment of the present invention, and FIG. 2 is a schematic perspective view of the contact. As shown in FIG. 1, the electrical connector 100 includes a housing 102 made of an insulating synthetic resin and having formed therein an insertion recess 101 for insertion of a connecting member, the contact 1 made of metal and held by the housing 102, and a slider 104 made of an insulating synthetic resin and having an insertion projection 103 that is inserted along an insertion direction X1 into the insertion recess 101 of the housing 102. The contact 1 is fixed to a substrate K by soldering, etc.

Referring to FIG. 2, the contact 1 is a so-called punched contact formed through a process of punching a plate material by a press. The contact 1 is a fork-shaped contact connected to a plate-like connecting member 60, which is a member, for example, of an FPC (flexible printed circuit), etc., and is inserted with zero insertion force along the insertion direction X1.

The contact 1 has one pair of plate surfaces 1a and 1b and a punched surface 1c intersecting the plate surfaces 1a and 1b and connecting the two plate surfaces 1a and 1b across an entire circumference. The contact 1 has a main body portion 2 with a substantially rectangular shape, a first arm portion 3 and a second arm portion 4 extending substantially in parallel in an opposite direction X2 (predetermined direction) of the insertion direction X1 from one end of the main body portion 2, and a substantially L-shaped lead portion 5 provided at another end of the main body portion 2.

As shown in FIG. 1 and FIG. 2, the first arm portion 3 functions as an elastic arm portion and includes a base end portion 6 coupled to the main body portion 2 and a tip end portion 7 that is a free end. The base end portion 6 of the first arm portion 3 has a press-fitting projection 6a and is press-fitted into a fixing hole 105 of the housing 102. A portion besides the base end portion 6 of the first arm portion 3 is housed and held in a first housing groove 107 formed in a first plate portion 106 of the housing 102 and facing the insertion recess 101.

The second arm portion 4 functions as a fixed arm portion and includes a base end portion 8 coupled to the main body portion 2 and a tip end portion 9. The second arm portion 4 is housed and held in a second housing groove 109 formed in a second plate portion 108 of the housing 102 and facing the insertion recess 101.

At its tip end portion 7, the first arm portion 3 is provided with a chevron portion 10 projecting toward the second arm portion 4 side in an intersecting direction Y1 intersecting the opposite direction X2 (predetermined direction). The chevron portion 10 of the first arm portion 3 penetrates into the insertion recess 101. As shown in FIG. 2, the chevron portion 10 is formed on a portion of the punched surface 1c that is a punched surface 1d of the first arm portion 3. The chevron portion 10 includes a projecting contact portion 11 that makes up an apex portion of the chevron portion 10 and one pair of inclined surface portions 12 and 13 disposed at respective sides of the contact portion 11.

The second arm portion 4 is made slightly shorter than the first arm portion 3. In regard to the opposite direction X2 (predetermined direction), a position of the contact portion 11 of the first arm portion 3 overlaps with a position of a portion (tip end portion 9) of the second arm portion 4. In other words, the contact portion 11 and a portion (tip end portion 9) of the second arm portion 4 face each other in the intersecting direction Y1.

Referring to FIG. 3, a gold plating layer 14 (corresponding to a hatched portion in FIG. 3) is coated on the punched surface 1d of the first arm portion 3. The gold plating layer 14 provided on the punched surface 1d of the first arm portion 3 is disposed only on the projecting contact portion 11.

As shown in FIG. 2, a conductive portion 61 provided on one surface of the connecting member 60 is connected to the contact portion 11 of the first arm portion 3. Gold plating is applied to the conductive portion 61. After the connecting member 60 is inserted between both arm portions 3 and 4 with zero insertion force (that is, without the connecting member 60 being in sliding contact with the contact portion 11), the slider 104 is inserted between the connecting member 60 and the second arm portion 4 and is thereby enabled to press the conductive portion 61 of the connecting member 60 against the contact portion 11. An elastic repulsive force of the first arm portion 3 as the elastic arm portion is applied via the contact portion 11 to the conductive portion 61 of the connecting member 60 and a predetermined contact pressure is thereby secured between the contact portion 11 and the conductive portion 61.

As shown in FIG. 4, a nickel plating layer 15 is provided as a dissimilar metal plating layer of a metal dissimilar to gold on an entirety of a surface of the contact 1, and the nickel plating layer 15 functions as a base plating layer at a region provided with the gold plating layer 14. At a region at which the gold plating layer 14 is not provided, the nickel plating layer 15 is exposed.

With the present preferred embodiment, an amount of gold can be reduced to reduce manufacturing cost because the gold plating layer 14 provided on the punched surface 1d of the first arm portion 3 is disposed only on the projecting contact portion 11 provided on the punched surface 1d.

Also, in the region in which the gold plating layer 14 is not provided, the nickel plating layer 15 that is capable of suppressing solder wetting is exposed and thus, for example, solder wicking at the lead portion 5 can be prevented effectively. Here, “solder wetting” refers to a phenomenon where melted solder spreads across a surface of a base material. Also, “solder wicking” refers to a phenomenon in which melted solder crawls up along a lead, etc.

Also, the first arm portion 3 and the second arm portion 4 are provided, and in regard to the opposite direction X2 (predetermined direction), the position of the contact portion 11 of the first arm portion 3 is overlapped with the position of a portion (tip end portion 9) of the second arm portion 4. In manufacturing the contact 1 of the present preferred embodiment, it is possible to employ, for example, the masking method using the inkjet arrangement according to Patent Document 1 to mask the required portions (portions not requiring the gold plating) before applying the gold plating and thereby provide the gold plating layer 14 on the minimum necessary region (only the contact portion 11 on the punched surface 1d of the first arm portion 3).

Although masking tends to be difficult to apply in the case where the contact portion 11 of the first arm portion 3 projects toward the second arm portion 4 side as in the present preferred embodiment, masking can be applied with good positional precision by employing, for example, the masking method using the inkjet arrangement according to Patent Document 1 to mask the required portions (portions not requiring the gold plating) before applying the gold plating.

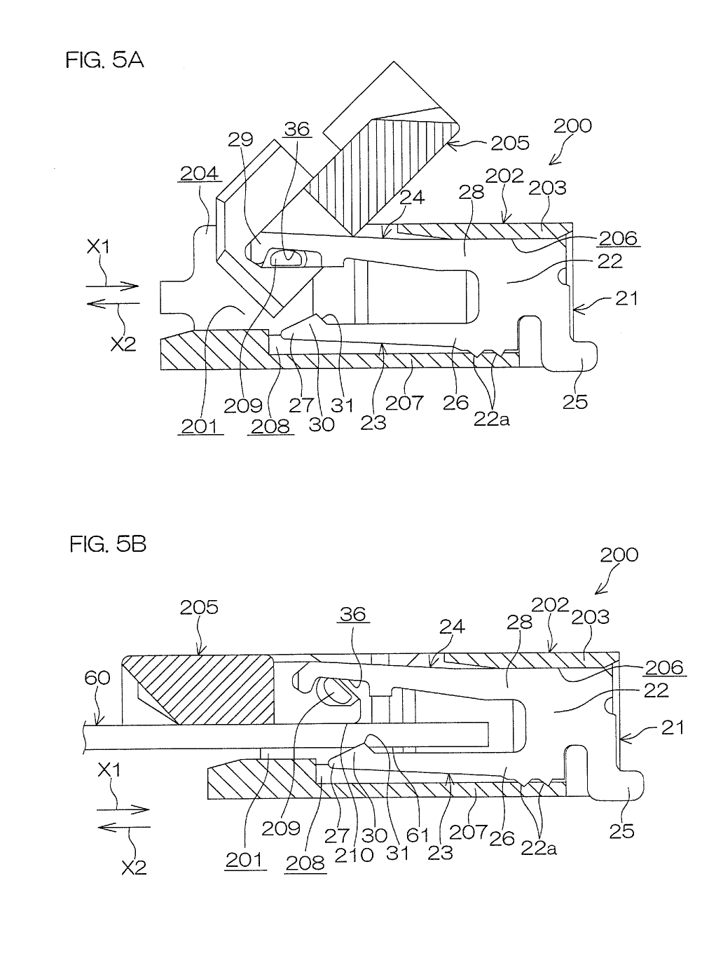

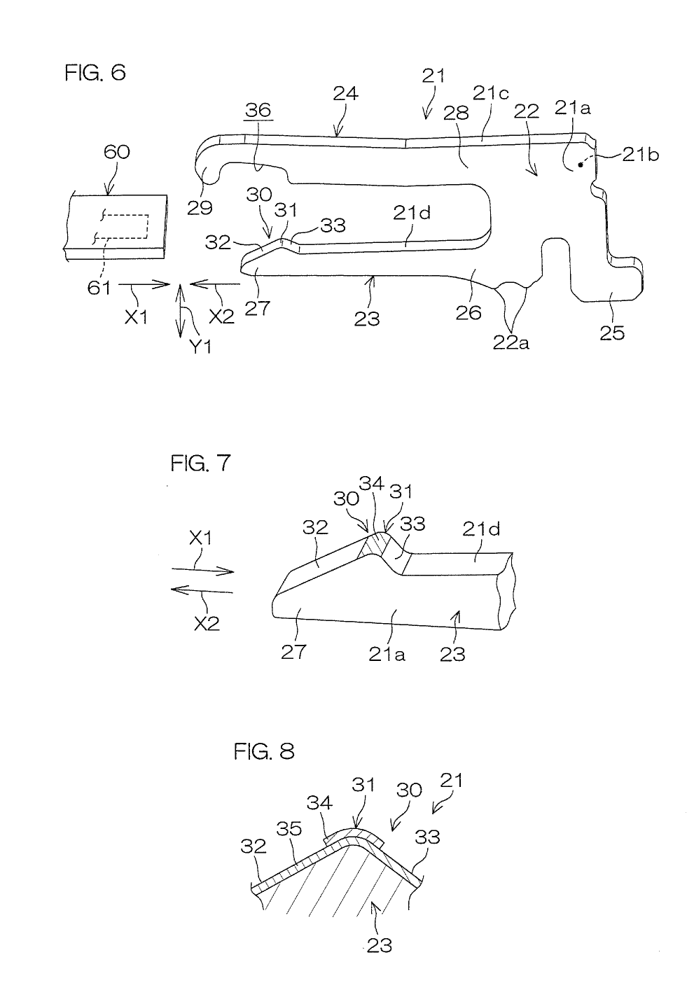

FIG. 5A and FIG. 5B are sectional views of an electrical connector that includes a contact according to another preferred embodiment of the present invention, and FIG. 6 is a schematic perspective view of the contact. As shown in FIG. 5A and FIG. 5B, the electrical connector 200 includes a housing 202 made of an insulating synthetic resin and defining an insertion recess 201 into which the connecting member 60 is inserted along the insertion direction X1, the contact 21 held by the housing 202 and disposed inside the insertion recess 201, and a cover 205 made of an insulating synthetic resin and being capable of rotating to open and close an opening 204 provided at a front half portion of a second plate portion 203 of the housing 202.

Referring to FIG. 6, the contact 21 is a so-called punched contact formed through a process of punching a plate material by a press. The contact 21 is a fork-shaped contact connected to the plate-like connecting member 60, which, for example, is a member of an FPC, etc., and is inserted with zero insertion force along the insertion direction X1.

The contact 21 has one pair of plate surfaces 21a and 21b and a punched surface 210 intersecting the plate surfaces 21a and 21b and connecting the two plate surfaces 21a and 21b across an entire circumference. The contact 21 has a main body portion 22 with a substantially rectangular shape, a first arm portion 23 and a second arm portion 24 extending substantially in parallel in the opposite direction X2 (predetermined direction) of the insertion direction X1 from one end of the main body portion 22, and a substantially L-shaped lead portion 25 provided at another end of the main body portion 22.

As shown in FIG. 5A, FIG. 5B, and FIG. 6, the main body portion 22 has a press-fitting projection 22a and is press-fitted into a fixing hole 206 of the housing 202. The first arm portion 23 is housed and held in a housing groove 208 formed in a first plate portion 207 of the housing 202 and facing the insertion recess 201. The first arm portion 23 functions as an elastic arm portion and includes a base end portion 26 coupled to the main body portion 22 and a tip end portion 27 that is a free end. The second arm portion 24 functions as a fixed arm portion and includes a base end portion 28 coupled to the main body portion 22 and a tip end portion 29.

Whereas in the preferred embodiment of FIG. 1, the first arm portion 3 is made longer than the second arm portion 4, in the present preferred embodiment, the second arm portion 24 is made longer than the first arm portion 23.

At its tip end portion 27, the first arm portion 23 is provided with a chevron portion 30 projecting toward the second arm portion 24 side in the intersecting direction Y1 intersecting the opposite direction X2 (predetermined direction). As shown in FIG. 6, the chevron portion 30 of the first arm portion 3 is formed on a portion of the punched surface 21c that is a punched surface 21d of the first arm portion 23. The chevron portion 30 includes a projecting contact portion 31 that makes up an apex portion of the chevron portion 30 and one pair of inclined surface portions 32 and 33 disposed at respective sides of the contact portion 31 in regard to the insertion direction X1.

The second arm portion 24 is made slightly longer than the first arm portion 23. In regard to the opposite direction X2 (predetermined direction), a position of the contact portion 31 of the first arm portion 23 overlaps with a position of a portion (tip end portion 9) of the second arm portion 24. In other words, the contact portion 31 and a portion (tip end portion 9) of the second arm portion 24 face each other in the intersecting direction Y1.

The second arm portion 24 has formed therein a recess 36 that faces the chevron portion 30. As shown in FIG. 5A and FIG. 5B, the recess 36 receives a rotation supporting shaft 209 provided in the cover 205 and functions as a rotation supporting portion that supports the cover 205 in a manner enabling rotation around the rotation supporting shaft 209.

Referring to FIG. 7, a gold plating layer 34 (corresponding to a hatched portion in FIG. 7) is coated on the punched surface 21d of the first arm portion 23. The gold plating layer 34 provided on the punched surface 21d of the first arm portion 23 is disposed only on the projecting contact portion 31.

As shown in FIG. 6, the conductive portion 61 provided on one surface of the connecting member 60 is connected to the contact portion 31 of the first arm portion 23. As shown in FIG. 5A, in a state where the cover 205 is open, the connecting member 60 is inserted between both arm portions 23 and 24 with zero insertion force (that is, without the connecting member 60 being in sliding contact with the contact portion 31). By the cover 205 being closed thereafter as shown in FIG. 5B, a pressing portion 210 of the cover 205 is enabled to press the conductive portion 61 of the connecting member 60 against the contact portion 31. An elastic repulsive force of the first arm portion 23 as the elastic arm portion is applied via the contact portion 31 to the conductive portion 61 of the connecting member 60 and a predetermined contact pressure is thereby secured between the contact portion 31 and the conductive portion 61.

As shown in FIG. 8, a nickel plating layer 35 is provided as a dissimilar metal plating layer on an entirety of a surface of the contact 21, and the nickel plating layer 35 functions as a base plating layer at a region provided with the gold plating layer 34. At a region at which the gold plating layer 34 is not provided, the nickel plating layer 35 is exposed.

The same actions and effects as those of the first preferred embodiment can be exhibited in the present preferred embodiment as well. That is, the amount of gold can be reduced to reduce the manufacturing cost because the gold plating layer 34 provided on the punched surface 21d of the first arm portion 23 is disposed only on the projecting contact portion 31 provided on the punched surface 21d.

Also, in the region in which the gold plating layer 34 is not provided, the nickel plating layer 35 that is capable of suppressing solder wetting is exposed and thus, for example, solder wicking at the lead portion 25 can be prevented effectively.

Also, the first arm portion 23 and the second arm portion 24 are provided, and in regard to the opposite direction X2 (predetermined direction), the position of the contact portion 31 of the first arm portion 23 is overlapped with the position of a portion (tip end portion 9) of the second arm portion 24. In manufacturing the contact 21 of the present preferred embodiment, it is possible to employ, for example, the masking method using the inkjet arrangement according to Patent Document 1 to mask the required portions (portions not requiring the gold plating) before applying the gold plating and thereby provide the gold plating layer 34 on the minimum necessary region (only the contact portion 31 on the punched surface 21d of the first arm portion 23).

Although masking tends to be difficult to apply in the case where the contact portion 31 of the first arm portion 23 projects toward the second arm portion 24 side as in the present preferred embodiment, masking can be applied with good positional precision by employing, for example, the masking method using the inkjet arrangement according to Patent Document 1 to mask the required portions (portions not requiring the gold plating) before applying the gold plating.

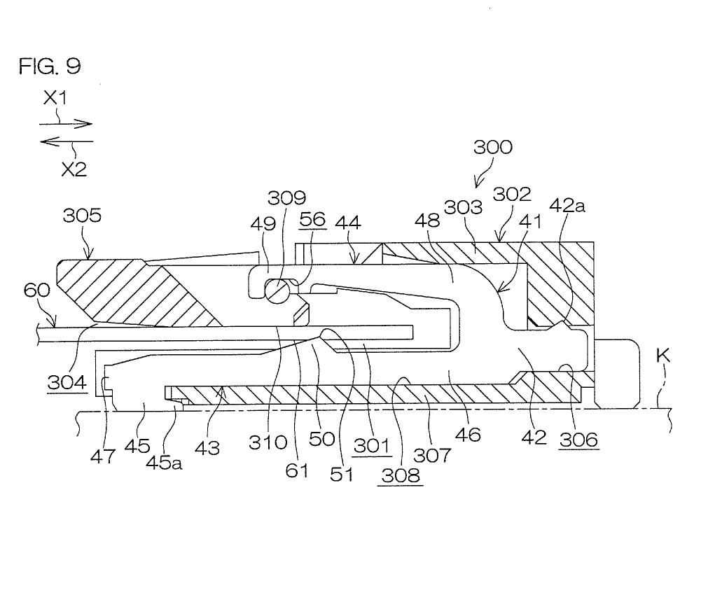

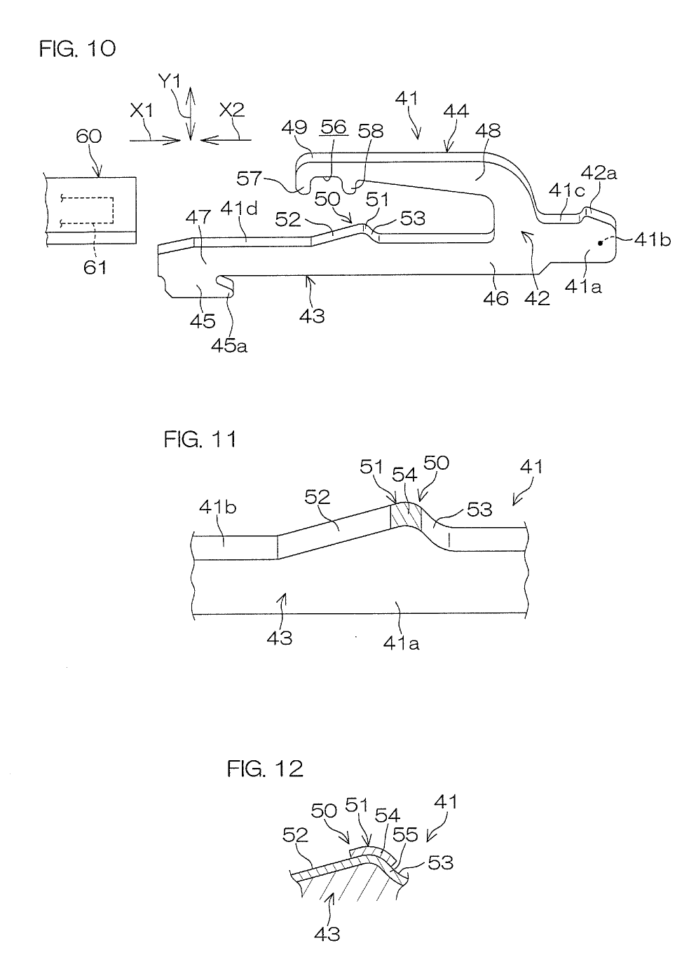

Next, FIG. 9 is a sectional view of an electrical connector that includes a contact according to another preferred embodiment of the present invention, and FIG. 10 is a schematic perspective view of the contact of FIG. 10. As shown in FIG. 9, the electrical connector 300 includes a housing 302 made of an insulating synthetic resin and defining an insertion recess 301 into which the connecting member 60 is inserted along the insertion direction X1, the contact 41 held by the housing 302 and disposed inside the insertion recess 301, and a cover 305 made of an insulating synthetic resin and being capable of rotating to open and close an opening 304 provided at a front half portion of a second plate portion 303 of the housing 302.

Referring to FIG. 10, the contact 41 is a so-called punched contact formed through a process of punching a plate material by a press. The contact 41 is a fork-shaped contact connected to the plate-like connecting member 60, which, for example, is a member of an FPC, etc., and is inserted with zero insertion force along the insertion direction X1.

The contact 41 has one pair of plate surfaces 41a and 41b and a punched surface 41c intersecting the plate surfaces 41a and 41b and connecting the two plate surfaces 41a and 41b across an entire circumference. The contact 41 has a main body portion 42 with a substantially hook-like shape, a first arm portion 43 and a second arm portion 44 extending substantially in parallel in the opposite direction X2 (predetermined direction) of the insertion direction X1 from one end of the main body portion 42, and a lead portion 45 provided at a tip end portion 47 of the first arm portion 43.

As shown in FIG. 9 and FIG. 10, the main body portion 42 has a press-fitting projection 42a and is press-fitted into a fixing hole 306 of the housing 302. The first arm portion 43 is housed and held in a housing groove 308 formed in a first plate portion 307 of the housing 302 and facing the insertion recess 301. The first armportion 43 includes the tip endportion 47 and a base end portion 46 coupled to the main body portion 42. A latching projection 45a provided at the lead portion 45 of the tip end portion 47 of the first arm portion 43 latches with an end portion of the first plate portion 307 of the housing 302. The first arm portion 43 thus functions as a fixed arm portion. The second arm portion 44 functions as an elastic arm portion and includes a base end portion 48 coupled to the main body portion 42 and a tip end portion 49 as a free end.

Whereas in the preferred embodiment of FIG. 1, the contact portion 11 is provided on the tip end portion 9 of the first arm portion 3, in the present preferred embodiment, a contact portion 51 is provided on an intermediate portion (in the example of FIG. 9, a substantially central portion) in a longitudinal direction of the first arm portion 43.

The first arm portion 43 is provided, at the intermediate portion in the longitudinal direction (corresponding to the opposite direction X2) thereof, with a chevron portion 50 projecting toward the second arm portion 44 side in the intersecting direction Y1 intersecting the opposite direction X2 (predetermined direction). As shown in FIG. 10, the chevron portion 50 of the first arm portion 43 is formed on a portion of the punched surface 41c that is a punched surface 41d of the first arm portion 43. The chevron portion 50 includes the projecting contact portion 51 that makes up an apex portion of the chevron portion 50 and one pair of inclined surface portions 52 and 53 disposed at respective sides of the contact portion 51.

The second arm portion 44 is made slightly shorter than the first arm portion 43. In regard to the opposite direction X2 (predetermined direction), a position of the contact portion 51 of the first arm portion 43 overlaps with a position of a portion of the second arm portion 44. In other words, the contact portion 51 and a portion of the second arm portion 44 face each other in the intersecting direction Y1.

The tip end portion 49 of the second arm portion 44 has formed therein a recess 56 that substantially faces the inclined surface portion 52 of the first arm portion 43. The recess 56 is formed between a pair of projections 57 and 58 projecting toward the first arm portion 43 side. As shown in FIG. 9, the recess 56 receives a rotation supporting shaft 309 provided in the cover 305 and functions as a rotation supporting portion that supports the cover 305 in a manner enabling rotation around the rotation supporting shaft 309.

Referring to FIG. 11, a gold plating layer 54 (corresponding to a hatched portion in FIG. 11) is coated on the punched surface 41d of the first arm portion 43. The gold plating layer 54 provided on the punched surface 41d of the first arm portion 43 is disposed only on the projecting contact portion 51.

As shown in FIG. 10, the conductive portion 61 provided on one surface of the connecting member 60 is connected to the contact portion 51 of the first arm portion 43. Although not illustrated, in a state where the cover 305 is open, the connecting member 60 is inserted between both arm portions 43 and 44 with zero insertion force (that is, without the connecting member 60 being in sliding contact with the contact portion 51), and by the cover 305 being closed thereafter as shown in FIG. 10, a pressing portion 310 of the cover 305 is enabled to press the conductive portion 61 of the connecting member 60 against the contact portion 51. An elastic repulsive force of the second arm portion 44 as the elastic arm portion is applied via the conductive portion 61 of the connecting member 60 to the contact portion 51 and a predetermined contact pressure is thereby secured between the contact portion 51 and the conductive portion 61.

As shown in FIG. 12, a nickel plating layer 55 is provided as a dissimilar metal plating layer on an entirety of a surface of the contact 41, and the nickel plating layer 55 functions as a base plating layer at a region provided with the gold plating layer 54. At a region at which the gold plating layer 54 is not provided, the nickel plating layer 55 is exposed.

The same actions and effects as the first preferred embodiment of FIG. 1 can be exhibited in the present preferred embodiment as well. That is, the amount of gold can be reduced to reduce the manufacturing cost because the gold plating layer 54 provided on the punched surface 41d of the first arm portion 43 is disposed only on the projecting contact portion 51 provided on the punched surface 41d.

Also, in the region in which the gold plating layer 54 is not provided, the nickel plating layer 55 that is capable of suppressing solder wetting is exposed and thus, for example, solder wicking at the lead portion 45 can be prevented effectively.

Also, the first arm portion 43 and the second arm portion 44 are provided, and in regard to the opposite direction X2 (predetermined direction), the position of the contact portion 51 of the first arm portion 43 is overlapped with the position of a portion (intermediate portion) of the second arm portion 44. In manufacturing the contact 41 of the present preferred embodiment, it is possible to employ, for example, the masking method using the inkjet arrangement according to Patent Document 1 to mask the required portions (portions not requiring the gold plating) before applying the gold plating and thereby provide the gold plating layer 54 on the minimum necessary region (only the contact portion 51 on the punched surface 41d of the first arm portion 43).

Although masking tends to be difficult to apply in the case where the contact portion 51 of the first arm portion 43 projects toward the second arm portion 44 side as in the present preferred embodiment, masking can be applied with good positional precision by employing, for example, the masking method using the inkjet arrangement according to Patent Document 1 to mask the required portions (portions not requiring the gold plating) before applying the gold plating.

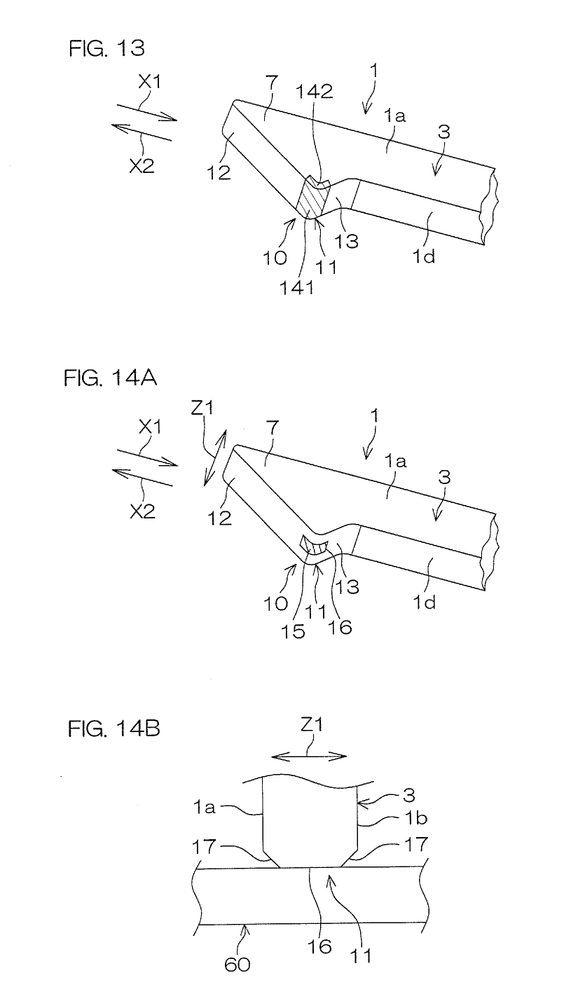

The present invention is not restricted to the preferred embodiments described above, and for example, as a modification example of the preferred embodiment of FIG. 1, it is preferable for a second gold plating layer 142, continuous with a first gold plating layer 141 as the gold plating layer of the punched surface 1d, to be provided at least on one of either of the pair of plate surfaces 1a and 1b (on the plate surface 1a in the example FIG. 13) as intersecting surfaces of the first arm portion 3 that intersect the punched surface 1d of the first arm portion 3 as shown in FIG. 13.

The following merit is provided in this case. That is, by visually or otherwise checking the presence of the second gold plating layer 142 on the plate surface 1a or 1b as the intersecting surface, the presence or non-presence of the first gold plating layer 141 of the punched surface 1d that is hard to recognize visually can be recognized. A simple inspection is thus enabled. The second plating layer 142 suffices to be of a small amount as long as its presence can be recognized visually and thus increase in manufacturing cost can be suppressed.

Also, although not illustrated, a second gold plating layer may be provided on at least one of either of the pair of plate surfaces 21a and 21b as intersecting surfaces in the preferred embodiment of FIG. 6, and a second gold plating layer may be provided on at least one of either of the pair of plate surfaces 41a and 41b as intersecting surfaces in the preferred embodiment of FIG. 10.

Also, as a modification example of the preferred embodiment of FIG. 3, the gold plating layer 14 coated on the apex portion making up the contact portion 11 may, as shown in FIG. 14A, be formed on a portion of the contact portion 11 (for example, at a central portion 16 in a plate thickness direction Z1 that is a punching direction). Usually, as shown in FIG. 14B, chamfered portions 17 are formed at both side edges in the plate thickness direction at the contact portion 11 of the contact 1, and the chamfered portions 17 do not contact the counterpart connecting member 60. Thus, by applying the gold plating restrictingly only at the central portion 16 (portion that actually contacts the counterpart connecting member 60) and excluding the chamfered portions 17 in the contact portion 11, further cost reduction can be achieved.

Also, although not illustrated, the gold plating layer 34 may be provided on a portion (for example, at a central portion in a plate thickness direction that is a punching direction) of the contact portion 31 in the preferred embodiment of FIG. 7, and the gold plating layer 54 may be provided on a portion of the contact portion 51 in the preferred embodiment of FIG. 11.

The present invention has been described in detail above by way of specific embodiments, and a person skilled in the art who has understood the above contents can readily conceive of changes, modifications, and equivalents thereof. The present invention shall thus be deemed to cover the scope of the claims and the scope of the equivalents of the claims.

The present application corresponds to Japanese Patent Application No. 2011-220022 filed on Oct. 4, 2011 in the Japan Patent Office, the entire disclosure of which is incorporated herein by reference.

1. A contact comprising:
an arm portion extending in a predetermined direction and having a punched surface formed by pressing; and
wherein the punched surface includes a projecting contact portion and a gold plating layer, and
the gold plating layer of the punched surface is provided only on the contact portion.

2. The contact according to claim 1, wherein
a dissimilar metal plating layer of a metal dissimilar to gold is provided on an entire surface of the arm portion, and the gold plating layer is provided on a surface of the dissimilar metal plating layer.

3. The contact according to claim 1, further comprising
a first arm portion as the arm portion, and
a second arm portion extending in parallel to the first arm portion, are included as the arm portion,
wherein in regard to a predetermined direction, a position of the contact portion of the first arm portion overlaps with a position of a portion of the second arm portion.

4. The contact according to claim 3, wherein
the projecting contact portion of the first arm portion projects toward the second arm portion.

5. The contact according to claim 1, wherein
the arm portion includes a plate surface that intersects the punched surface, and
a second gold plating layer, continuous with a first gold plating layer as the gold plating layer on the punched surface, is provided on the plate surface.

6. The contact according to claim 1, wherein
the gold plating layer is disposed only at a central portion in a plate thickness direction as a punching direction of the punched surface.

7. An electrical connector comprising:
a contact; and
an insulating housing holding the contact; and
wherein the contact includes an arm portion extending in a predetermined direction and having a punched surface formed by pressing;
the punched surface includes a projecting contact portion and a gold plating layer, and
the gold plating layer of the punched surface is provided only on the contact portion.
